(19) United States
(12) Patent Application Publication
(10) Pub. No.: US 2006/0171267 A1
(43) Pub. Date: Aug. 3, 2006

(54) Optical disk apparatus

(75) Inventors: Toshiaki Fukui, Daito (JP); Hiroshi Mitsuda, Daito (JP)

Correspondence Address: BACON & THOMAS, PLLC, 625 SLATERS LANE, FOURTH FLOOR, ALEXANDRIA, VA, 22314, US

(73) Assignee: FUNAI Electric Co., Ltd., Daito (JP)

(21) Appl. No.: 11/342,580

(22) Filed: Jan. 31, 2006

(30) Foreign Application Priority Data
Feb. 2, 2005 (JP) 2005-26208

(51) Int. Cl. G11B 7/00

(52) U.S. Cl. 369/44.32; 369/44.28; 369/44.34

(57) ABSTRACT

There is provided an optical disk apparatus having a function capable of preventing a focusing error detecting function from operating during a seeking operation with a simple circuit configuration. If crosstalk level determining means 43 determines that the signal level of a crosstalk measured in crosstalk level measuring means 42 is equal to or greater than a threshold value, focus gain reducing means 44 reduces the gain of an amplifier 45, that is, the focus gain in accordance with the signal level of the crosstalk during a seeking operation. It is therefore possible to prevent a focusing error detecting function from operating during a seeking operation and thereby to prevent a seeking error, which can eliminate the need for an operational circuit to prevent a focusing error with a simple circuit configuration, resulting also in cost reduction.

### BACKGROUND OF THE INVENTION

1. Field of the Invention

The present invention relates to an optical disk apparatus for reproducing information recorded on an optical disk or for recording/reproducing information onto/from an optical disk, and more particularly to an optical disk apparatus having a function of reducing a crosstalk component of a tracking error signal that appears in a focusing error signal.

2. Description of the Prior Art

Conventionally, optical disk apparatuses comprise an optical pickup for emitting a laser beam for reproducing or recording/reproducing information onto/from an optical disk and for receiving reflected light from the optical disk and a servo control section for performing tracking servo and focusing servo for the optical pickup with respect to the optical disk.

Meanwhile, the optical pickup comprises a light detector having four light receiving regions (composed of four light receiving elements such as photodiodes) that are arranged in a two-by-two matrix shape to receive reflected light from an optical disk, where if there is a margin of error in the mounting position of these light receiving elements, there occurs a phenomenon that the component of a tracking error signal affects a focusing error signal, that is, a T-F crosstalk (hereinafter referred to simply as crosstalk) during a track jumping across lands and grooves on the optical disk, which may cause a focusing error of a laser beam emitted from the optical pickup and/or cause focusing servo less likely to be turned on. Hence, the focus gain for focusing servo is reduced by a predetermined decibel (e.g. −3 dB) constantly during a seeking operation, where if the signal level of a crosstalk is so high as to run short of the reduction range, a focusing error detecting function may be operated to cause a seeking error.

Hence, in order to prevent a focusing error detecting function from operating during a seeking operation due to a crosstalk phenomenon, the prior art described in Japanese Patent Laid-Open Publication No. 2004-227694 provides crosstalk level determining means for determining whether or not a crosstalk component is greater than a predetermined level during a trial track jumping, wherein crosstalk correcting means is adapted to carry out an operation for reducing the crosstalk component if the crosstalk level determining means determines that the crosstalk component is greater than the predetermined level.

Also, the prior art described in Japanese Patent Laid-Open Publication No. Hei 7-169070 provides: a multiplier and a regulator for generating a correction signal with the phase and the amplitude thereof matching those of a crosstalk in a focusing error signal based on a tracking error signal and a summation signal when a light beam from an optical head traverses tracks on an optical disk; and a correction adding point at which the correction signal is applied to the focusing servo loop, wherein the crosstalk is adapted to be cancelled by applying the correction signal to the focusing servo loop and by preparing and referring to a data table that indicates the correspondence between tracking error signals and crosstalk components.

However, in the prior art described in Japanese Patent Laid-Open Publication No. 2004-227694, it is necessary to provide an operational circuit for carrying out an operation for reducing a crosstalk component if it is determined that the crosstalk component is greater than a predetermined level. That is, it is necessary to provide an operational circuit (crosstalk correcting means, crosstalk level determining means, variation width ratio detecting means, first counting means, and second counting means) for calculating a crosstalk value, generating a crosstalk signal, and adding the crosstalk signal to a focusing drive signal to be offset, resulting in a problem in that the circuit becomes complicated.

Also, in the prior art described in Japanese Patent Laid-Open Publication No. Hei 7-169070, it is necessary to provide, for example, a multiplier and a regulator for generating a correction signal with the phase and the amplitude thereof matching those of a crosstalk in a focusing error signal based on a tracking error signal and a summation signal when a light beam from an optical head traverses tracks on an optical disk, resulting also in a problem in that the circuit becomes complicated.

### SUMMARY OF THE INVENTION

The present invention has been made to solve the above-described problems, and an object thereof is to provide an optical disk apparatus having a function capable of preventing a focusing error detecting function from operating during a seeking operation with a simple circuit configuration.

In order to achieve the foregoing object, the invention according to claim 1 provides an optical disk apparatus wherein a servo control section comprises: crosstalk level measuring means for measuring the signal level of a crosstalk as a phenomenon that the component of a tracking error signal for tracking servo affects a focusing error signal for focusing servo; crosstalk level determining means adapted to preset a threshold value for the signal level of a crosstalk at which there is a possibility of a focusing error during a seeking operation to determine whether or not the signal level of the measured crosstalk is equal to or greater than the threshold value; and focus gain reducing means for reducing the focus gain for focusing servo in accordance with the signal level of the crosstalk during a seeking operation if it is determined that the signal level of the crosstalk is equal to or greater than the threshold value.

In the arrangement above, if the crosstalk level determining means determines that the signal level of the crosstalk measured in the crosstalk level measuring means is equal to or greater than the threshold value, the focus gain reducing means reduces the focus gain for focusing servo in accordance with the signal level of the crosstalk during a seeking operation.

In accordance with the above arrangement, the signal level of a crosstalk is measured, and the focus gain for focusing servo is reduced in accordance with the signal level of the crosstalk if the signal level is equal to or greater than a threshold value, whereby it is possible to prevent a focusing error detecting function from operating during a seeking operation and thereby to prevent a seeking error, which can eliminate the need for an operational circuit to prevent a focusing error with a simple circuit configuration, resulting also in cost reduction.

The invention according to claim 2 provides an optical disk apparatus wherein a servo control section has a function of measuring the signal level of a crosstalk as a phenomenon that the component of a tracking error signal for tracking servo affects a focusing error signal for focusing servo and of changing the focus gain for focusing servo during a seeking operation in accordance with the signal level of the measured crosstalk.

In the arrangement above, the focus gain for focusing servo during a seeking operation is changed in accordance with the signal level of the measured crosstalk. Therefore, in accordance with the above arrangement, it is possible to prevent a focusing error detecting function from operating during a seeking operation and thereby to prevent a seeking error, which can eliminate the need for an operational circuit to prevent a focusing error with a simple circuit configuration, resulting also in cost reduction.

In the invention according to claim 3, the invention according to claim 2 is arranged in such a manner that the servo control section further has a function of presetting a threshold value for the signal level of a crosstalk at which there is a possibility of a focusing error during a seeking operation and of reducing the focus gain for focusing servo in accordance with the signal level of the crosstalk if the signal level of the measured crosstalk is equal to or greater than the threshold value, whereby it is possible to prevent a focusing error detecting function from operating during a seeking operation with a simple circuit configuration.

In the invention according to claim 4, the invention according to claim 3 is arranged in such a manner that the servo control section comprises: crosstalk level measuring means for measuring the signal level of a crosstalk; crosstalk level determining means adapted to preset a threshold value for the signal level of a crosstalk at which there is a possibility of a focusing error during a seeking operation to determine whether or not the signal level of the measured crosstalk is equal to or greater than the threshold value; and focus gain reducing means for reducing the focus gain for focusing servo in accordance with the signal level of the crosstalk during a seeking operation if it is determined that the signal level of the crosstalk is equal to or greater than the threshold value, whereby it is possible to achieve processes for: measuring the signal level of a crosstalk; determining whether or not the signal level of the measured crosstalk is equal to or greater than the threshold value; and reducing the focus gain if it is determined that the signal level of the crosstalk is equal to or greater than the threshold value

As described heretofore, in accordance with the present invention, a servo control section comprises: crosstalk level measuring means for measuring the signal level of a crosstalk as a phenomenon that the component of a tracking error signal for tracking servo affects a focusing error signal for focusing servo; crosstalk level determining means adapted to preset a threshold value for the signal level of a crosstalk at which there is a possibility of a focusing error during a seeking operation to determine whether or not the signal level of the measured crosstalk is equal to or greater than the threshold value; and focus gain reducing means for reducing the focus gain for focusing servo in accordance with the signal level of the crosstalk during a seeking operation if it is determined that the signal level of the crosstalk is equal to or greater than the threshold value. Therefore, the signal level of a crosstalk can be measured, and the focus gain for focusing servo can be reduced in accordance with the signal level of the crosstalk if the signal level is equal to or greater than a threshold value, whereby it is possible to prevent a focusing error detecting function from operating during a seeking operation and thereby to prevent a seeking error, which can eliminate the need for an operational circuit to prevent a focusing error with a simple circuit configuration, resulting also in cost reduction.

Also, in accordance with the present invention, a servo control section has a function of measuring the signal level of a crosstalk as a phenomenon that the component of a tracking error signal for tracking servo affects a focusing error signal for focusing servo and of changing the focus gain for focusing servo during a seeking operation in accordance with the signal level of the measured crosstalk, whereby it is possible to prevent a focusing error detecting function from operating during a seeking operation and thereby to prevent a seeking error, which can eliminate the need for an operational circuit to prevent a focusing error with a simple circuit configuration, resulting also in cost reduction.

### BRIEF DESCRIPTION OF THE DRAWINGS

FIG. 1 is a block diagram showing the configuration of an optical disk apparatus according to an embodiment of the present invention;

FIG. 2 is a block diagram illustrating the arrangement for focusing servo in the servo control section shown in FIG. 1;

FIG. 3 is a block diagram showing the configuration of detecting regions in the optical pickup and an error signal generating circuit in the embodiment;

FIG. 4 is a signal waveform diagram for illustrating a state where a crosstalk signal appears in a focusing error signal in the embodiment; and

FIG. 5 is a flow chart for illustrating a process for reducing the focus gain in accordance with the signal level of a crosstalk if there is a possibility of a focusing error during a seeking operation in the embodiment.

### DESCRIPTION OF THE PREFERRED EMBODIMENTS

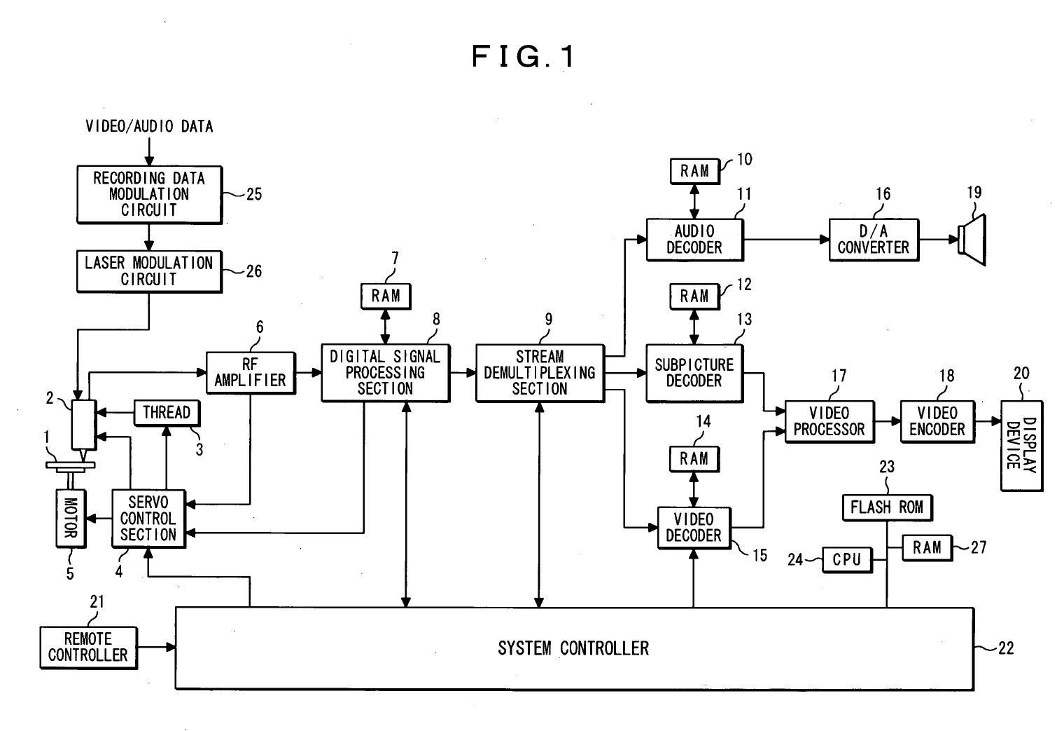

An embodiment of the present invention will hereinafter be described with reference to the accompanying drawings. FIG. 1 is a block diagram showing the configuration of an optical disk apparatus according to an embodiment of the present invention. Although here will be described the configuration of an optical disk apparatus such as a DVD recorder, it will be appreciated that the process for changing the focus gain can also be applied to an optical disk apparatus such as a DVD player.

The optical disk apparatus comprises: a spindle motor 5 for rotating an optical disk 1; an optical pickup 2 for emitting a laser beam to record/reproduce information onto/from the optical disk 1 and for receiving reflected light from the optical disk 1; a thread 3 for moving the optical pickup 2 in the radial direction of the optical disk 1; and a servo control section 4 for driving the spindle motor 5 and the thread 3 in accordance with an instruction from a system controller 22 and for moving an objective lens (not shown in the figure) built in the optical pickup 2 to move the focus position of the laser beam vertically and horizontally with respect to the recording surface of the optical disk 1.

The optical disk apparatus also comprises: an RF amplifier 6 for amplifying an RF signal as a readout signal from the optical pickup 2 when reproducing the optical disk 1; a digital signal processing section 8 for performing signal demodulation processing and ECC error correction processing in accordance with the data format of the optical disk 1 after converting an RF signal output from the RF amplifier 6 into digital data and then storing the generated data in a RAM 7; and a stream demultiplexing section 9 for demultiplexing data stream output from the digital signal processing section 8 in accordance with an instruction from the system controller 22 into audio data, subpicture data, and video data.

The optical disk apparatus further comprises: an audio decoder 11 for receiving audio data output from the stream demultiplexing section 9 to perform predetermined decode processing; a RAM 10 for temporarily storing data to be subject to the decode processing in the audio decoder 11; a subpicture decoder 13 for receiving subpicture data output from the stream demultiplexing section 9 to perform predetermined decode processing; a RAM 12 for temporarily storing data to be subject to the decode processing in the subpicture decoder 13; a video decoder 15 for receiving video data output from the stream demultiplexing section 9 to perform predetermined decode processing; and a RAM 14 for temporarily storing data to be subject to the decode processing in the video decoder 15.

The optical disk apparatus still further comprises: a video processor 17 for synthesizing data output from the video decoder 15 and data output from the subpicture decoder 13 in accordance with an instruction from the system controller 22; a video encoder 18 for converting synthesized data output from the video processor 17 into a video signal for display to display an image on a display device 20; and a D/A converter 16 for converting data output from the audio decoder 11 into an analog audio signal to be fed to, for example, a speaker 19.

The optical disk apparatus also comprises: a remote controller 21 having various kinds of operation keys such as a reproduction key for instructing the system controller 22 to start reproduction using an infrared signal, a stop key for instructing to stop reproduction, a record key for instructing to start recording, and a power key; and the system controller 22 for controlling the entire apparatus.

Further, the optical disk apparatus comprises: a flash ROM 23 with programs and data for controlling the components in the apparatus and the entire apparatus stored therein; a CPU 24 for performing arithmetic processing based on the programs and data in the flash ROM 23 to control the system controller 22; and a RAM 27 for temporarily storing data required for the processing in the CPU 24.

Furthermore, the optical disk apparatus comprises: a recording data modulation circuit 25 for modulating video/audio data sent from a TV receiver or a personal computer, etc. (not shown in the figure) to be recorded on the optical disk 1; and a laser modulation circuit 26 for outputting a laser modulation signal, which is adapted to modulate a laser beam to be emitted from the optical pickup 2 based on modulation data modulated by the recording data modulation circuit 25, to the optical pickup 2.

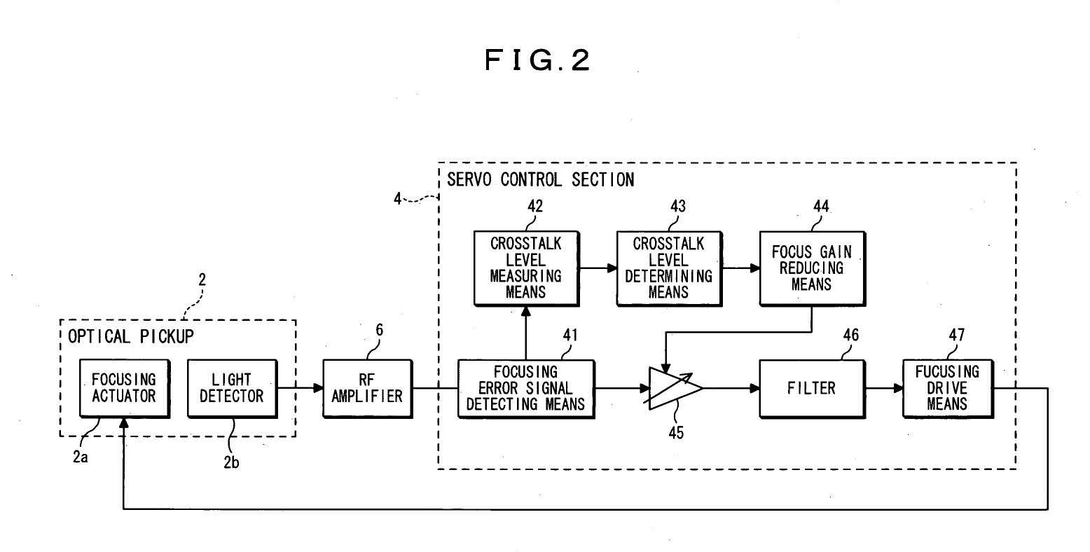

FIG. 2 is a block diagram illustrating the arrangement for focusing servo in the servo control section 4 shown in FIG. 1. In FIG. 2, the servo control section 4 comprises: focusing error signal detecting means 41 for detecting a focusing error signal included in an RF signal from the RF amplifier 6; crosstalk level measuring means 42 for measuring the signal level of a crosstalk as a phenomenon that a tracking error signal affects a focusing error signal; and crosstalk level determining means 43 adapted to preset a threshold value for the signal level of a crosstalk at which there is a possibility of a focusing error during a seeking operation to determine whether or not the signal level of the measured crosstalk is equal to or greater than the threshold value.

The servo control section 4 also comprises: focus gain reducing means 44 for reducing the focus gain (the gain of an amplifier 45) for focusing servo in accordance with the signal level of the crosstalk during a seeking operation if it is determined that the signal level of the crosstalk is equal to or greater than the threshold value; the amplifier 45 for receiving and amplifying the focusing error signal; a filter 46 for receiving the focusing error signal from the amplifier 45 to remove spurious frequency components; and focusing drive means 47 for outputting a focusing drive signal based on the focusing error signal that passes through the filter 46 to drive the focusing actuator 2a in the optical pickup 2.

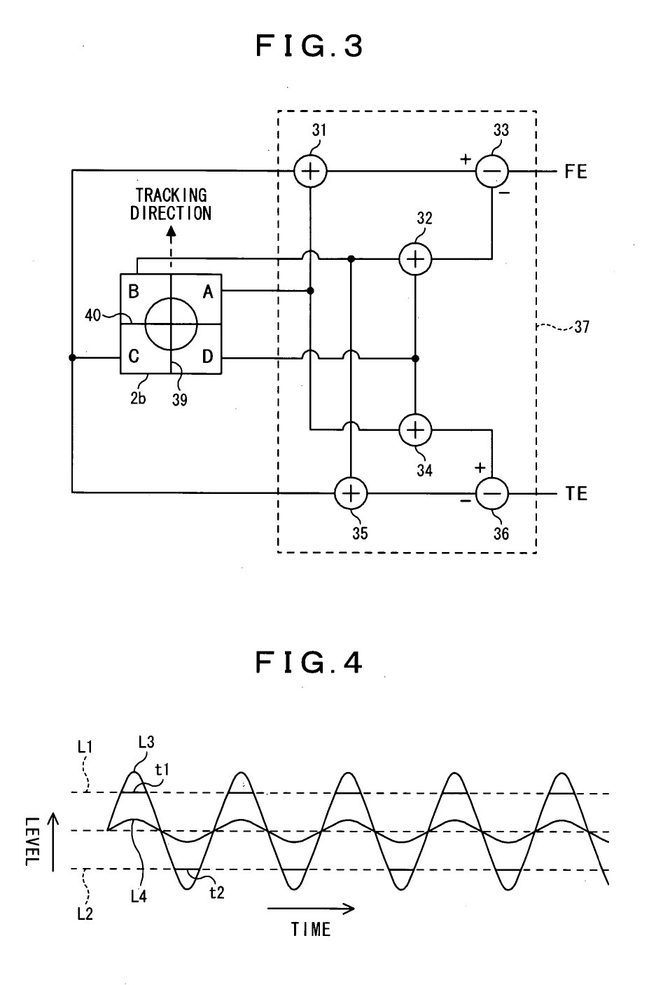

FIG. 3 is a block diagram showing the configuration of detecting regions in the optical pickup and an error signal generating circuit in the present embodiment. As shown in FIG. 3, the light detector 2b in the optical pickup 2 is divided by an axis 39 parallel to the tracking direction and an axis 40 perpendicular to the tracking direction to have four detecting regions A, B, C, and D. The error signal generating circuit 37 is composed of four adders 31, 32, 34, 35 and two subtracters 33, 36.

The adder 31 is adapted to add outputs from the detecting regions A and C among the four detecting regions A, B, C, and D. The adder 32 is also adapted to add outputs from the detecting regions B and D among the four detecting regions A, B, C, and D. Then, the subtracter 33 is adapted to subtract an output from the adder 32 from an output from the adder 31, and to output the subtracted result as a focusing error signal FE.

The adder 34 is adapted to add outputs from the detecting regions A and D among the four detecting regions A, B, C, and D. The adder 35 is also adapted to add outputs from the detecting regions B and C among the four detecting regions A, B, C, and D. Then, the subtracter 36 is adapted to subtract an output from the adder 35 from an output from the adder 34, and to output the subtracted result as a push-pull tracking error signal TE.

FIG. 4 is a signal waveform diagram for illustrating a state where a crosstalk signal appears in a focusing error signal in the present embodiment. In FIG. 4, the lines L1 and L2 indicate threshold levels for the signal level of a crosstalk at which there is a possibility of a focusing error during a seeking operation. The line L3 indicates a focusing error signal with a crosstalk signal appearing therein. The line L4 indicates a normal focusing error signal with no crosstalk signal appearing therein. The symbol t1 indicates the time for which the focusing error signal indicated by the line L3 is equal to or greater than the threshold value indicated by the line L1. The symbol t2 indicates the time for which the focusing error signal indicated by the line L3 is equal to or smaller than (greater than in absolute value) the threshold value indicated by the line L2.

In conventional optical disk apparatuses, a focusing error detecting function is adapted to operate when the times t1 and t2 become equal to or greater than a predetermined time period. Then, in the present embodiment, if the signal level of a crosstalk is equal to or greater than a threshold value, the gain of the amplifier 45 shown in FIG. 2 is controlled to decrease to prevent a focusing error detecting function from operating.

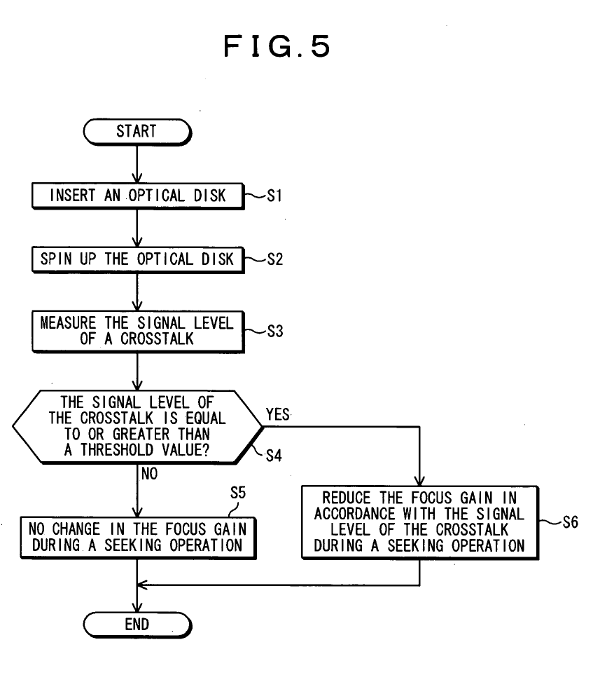

FIG. 5 is a flow chart for illustrating a process for reducing the focus gain in accordance with the signal level of a crosstalk if there is a possibility of a focusing error during a seeking operation in the present embodiment. A process for reducing the focus gain in accordance with the signal level of a crosstalk if there is a possibility of a focusing error during a seeking operation will be described with reference to this flow chart.

An optical disk 1 is inserted into the optical disk apparatus (step S1), and then spun up (step S2). That is, after inserting the optical disk 1 into the optical disk apparatus, the optical disk 1 is rotated and recorded information is read from the optical disk 1 by the optical pickup 2. Then, an RF signal is output from the light detector 2b in the optical pickup 2 (refer to FIG. 2) to be amplified in the RF amplifier 6 to be input into the servo control section 4.

In the servo control section 4, a tracking error signal included in the input RF signal is detected by tracking error signal detecting means (not shown in the figure), and then the tracking error signal is input into tracking drive means (not shown in the figure). Thus, a tracking drive signal is generated and fed to a tracking actuator (not shown in the figure) in the optical pickup 2 to drive the tracking actuator and thereby to perform tracking servo control. Meanwhile, a focusing error signal included in the input RF signal is detected by the focusing error signal detecting means 41 (refer to FIG. 2), and then the focusing error signal is input into the focusing drive means 47 (refer to FIG. 2) through the amplifier 45 and the filter 46. Thus, a focusing drive signal is generated and fed to the focusing actuator 2a (refer to FIG. 2) in the optical pickup 2 to drive the focusing actuator 2a and thereby to perform focusing servo control.

After the optical disk 1 is spun up (step S2), the crosstalk level measuring means 42 in the servo control section 4 measures the signal level of a crosstalk in the focusing error signal from the focusing error signal detecting means 41 (step S3). For example, the level of the focusing error signal (line L3) shown in FIG. 4 is to be measured. Then, the crosstalk level determining means 43 in the servo control section 4 determines whether or not the signal level of the crosstalk is equal to or greater than a threshold value (step S4). For example, it is to be determined whether or not the level of the focusing error signal (line L3) shown in FIG. 4 is equal to or greater than the threshold value (line L1).

If the signal level of the crosstalk is less than the threshold value, the focusing error detecting function is not to be operated, and therefore the gain of the amplifier 45 remains in the present state during a seeking operation to make no change in the focus gain (step S5). However, if it is determined that the signal level of the crosstalk is equal to or greater than the threshold value, the focus gain reducing means 44 in the servo control section 4 reduces the gain of the amplifier 45, that is, the focus gain in accordance with the signal level of the crosstalk during a seeking operation (step S6).

As described heretofore, in accordance with the present embodiment, the signal level of a crosstalk is measured, and the focus gain for focusing servo is reduced in accordance with the signal level of the crosstalk if the signal level is equal to or greater than a threshold value, whereby it is possible to prevent a focusing error detecting function from operating during a seeking operation and thereby to prevent a seeking error, which can eliminate the need for an operational circuit to prevent a focusing error with a simple circuit configuration, resulting also in cost reduction.

What is claimed is:

1. An optical disk apparatus comprising an optical pickup for emitting a laser beam for reproducing or recording/reproducing information onto/from an optical disk and for receiving reflected light from said optical disk and a servo control section for performing tracking servo and focusing servo for said optical pickup with respect to said optical disk, said apparatus being adapted to reproduce information recorded on said optical disk or to record/reproduce information onto/from said optical disk, wherein
said servo control section comprises:
crosstalk level measuring means for measuring the signal level of a crosstalk as a phenomenon that the component of a tracking error signal for tracking servo affects a focusing error signal for focusing servo;
crosstalk level determining means adapted to preset a threshold value for the signal level of a crosstalk at which there is a possibility of a focusing error during a seeking operation to determine whether or not the signal level of said measured crosstalk is equal to or greater than said threshold value; and
focus gain reducing means for reducing the focus gain for focusing servo in accordance with the signal level of said crosstalk during a seeking operation if it is determined that the signal level of said crosstalk is equal to or greater than said threshold value.

2. An optical disk apparatus comprising an optical pickup for emitting a laser beam for reproducing or recording/reproducing information onto/from an optical disk and for receiving reflected light from said optical disk and a servo control section for performing tracking servo and focusing servo for said optical pickup with respect to said optical disk, said apparatus being adapted to reproduce information recorded on said optical disk or to record/reproduce information onto/from said optical disk, wherein
said servo control section has a function of measuring the signal level of a crosstalk as a phenomenon that the component of a tracking error signal for tracking servo affects a focusing error signal for focusing servo and of changing the focus gain for focusing servo during a seeking operation in accordance with the signal level of said measured crosstalk.

3. The optical disk apparatus according to claim 2, wherein
said servo control section further has a function of presetting a threshold value for the signal level of a crosstalk at which there is a possibility of a focusing error during a seeking operation and of reducing the focus gain for focusing servo in accordance with the signal level of said crosstalk if the signal level of said measured crosstalk is equal to or greater than said threshold value.

4. The optical disk apparatus according to claim 3, wherein
said servo control section comprises:
crosstalk level measuring means for measuring the signal level of a crosstalk;
crosstalk level determining means adapted to preset a threshold value for the signal level of a crosstalk at which there is a possibility of a focusing error during a seeking operation to determine whether or not the signal level of said measured crosstalk is equal to or greater than said threshold value; and
focus gain reducing means for reducing the focus gain for focusing servo in accordance with the signal level of said crosstalk during a seeking operation if it is determined that the signal level of said crosstalk is equal to or greater than said threshold value.
